(19) United States
(12) Patent Application Publication
(10) Pub. No.: US 2004/0265185 A1
(43) Pub. Date: Dec. 30, 2004

(54) Method of washing liquid pipetting apparatus and dispensing head

(75) Inventor: Hideya Kitagawa, Hino City (JP)

Correspondence Address: SCULLY SCOTT MURPHY & PRESSER, PC, 400 GARDEN CITY PLAZA, GARDEN CITY, NY, 11530

(73) Assignee: OLYMPUS CORPORATION, TOKYO (JP)

(21) Appl. No.: 10/830,469

(22) Filed: Apr. 22, 2004

(30) Foreign Application Priority Data
Apr. 22, 2003 (JP) 2003-116,962

(51) Int. Cl. G01N 35/02

(52) U.S. Cl. 422/100; 436/49

(57) ABSTRACT

In order to prevent the opening of the dispensing head from being blocked, the liquid pipetting apparatus having the strengthened washing capability is provided. A liquid pipetting apparatus for sucking and discharging a minute amount of liquid, comprising, has first opening 54 for sucking and discharging liquid at one end and second opening 45a for draining the liquid at an another end. The apparatus comprises a dispensing head 2 for holding the liquid inside thereof, washing tanks 7, 8 for holding cleaning solution to wash the inside of the dispensing head 2, and a head inside washing means for washing inside of the dispensing head, by sucking the cleaning solution from the opening 46a, under the state of soaking the one end of the dispensing head 2 in washing tanks 7 and 8 and for dispensing sucked cleaning solution from the opening 46a (for example, the decompressing tank 22 and the vacuum pump 25).

### BACKGROUND OF INVENTION

1. Field of the Invention

The present invention relates to a liquid pipetting apparatus for performing a sucking and a discharging of a minute amount of liquid, particularly, a liquid pipetting apparatus for strengthening a washing function of dispensing head, and a method of washing a dispensing head.

2. Explanation of Related Technology

In the test apparatus such as a blood analyzer, a genetic test, and a pharmaceutical inspection, it is examined to make a minimum discharge amount of the liquid discharging device installed in these devices minute for the reduction in the running cost and the improvement of throughput. As one example, a minute amount fluid processing unit capable of discharging the liquid drop of less than one nano-liter, is proposed. (For example, refer to Japanese Patent Application Opened No. 114394/1998)

The minute amount fluid processing unit 160 comprises, as shown in the FIG. 6, a micro dispenser 161 using a piezoelectric transducer fitted to a glass capillary, a positive displacement pump 162 that fills fluid to be transported to the micro dispenser 161, sucks fluid to be transported from the micro dispenser 161, controls pressure of the system fluid, and washes the micro dispenser 161 between one fluid transportation and another fluid transportation, and a pressure sensor 163 that measures pressure of the system fluid, and generates a corresponding electric signal.

The micro dispenser 161 comprises a glass capillary 164 and a piezo-electric ceramics tube 165 combined to the glass capillary 164 as shown in FIG. 7. The piezo-electric ceramics tube 165 has an inner electrode 166 and an outer electrode 167 for receiving analog voltage pulses to shrink the piezo-electric ceramics tube 165. When the liquid is discharged by using the minute amount fluid processing unit 160, the analog voltage pulse is sent to the piezo-electric ceramics tube 165, the shrinkage of the piezo-electric ceramics tube 165 is caused, and the glass capillary 164 is transformed by the shrinkage. The pressure wave progressing in the transporting fluid and reaching a nozzle 168 of the micro dispenser, is formed by the transformation of the glass capillary 164, so that one liquid drop of the transporting fluid is ejected with an extremely high acceleration from the opening in the tip of the nozzle 168. In the above prior Japanese Patent Application Opened No. 114394/1998, the effect that the liquid drop of, for example, five pico-liter can be discharged, has been described. Moreover, as a suitable example in the opening of the nozzle tip, another example of the tip opening with 75 microns in inner diameter has been enumerated.

The transporting fluid sucked as a specimen in the minute amount fluid processing unit 160 is pipetted and is supplied in and to a general specimen container 170 that is called a microtiter plate shown in FIG. 8 by a cross-section, and in the prior art, the sucking is performed by infiltrating the nozzle of glass capillary 164 in micro dispenser 161 infiltrated in the specimen.

Moreover, in the case of continuous pipetting while changing the kind of the specimen into many kinds, the nozzle must be washed before the following specimen is sucked, so that in the prior art, the system fluid is fed forcefully by positive displacement pump 162, and drained the remaining specimen from the nozzle tip. At this time, the ultrasonic vibration is given to the micro dispenser 161, thereby preventing the block according to the adhesion of the substance in the transporting fluid.

In the field of the blood analysis, the genetic test, and the pharmaceutical inspection, as a discharging specimen, the specimen, in which the liquid of high viscosity and high sorbent and particles such as fine particles and cells are distributed, might be used. On the other hand, there is a case that as for the minute amount fluid processing apparatus of above prior art, the foreign body are mixed in the micro dispenser, the positive displacement pump, and the conduit connected to these members, and the microorganism of mold etc. is generated in the stay portion of the fluid. Therefore, in this case, when the system fluid is fed forcefully, and the system fluid is drained from the opening of the nozzle tip, above foreign body and the microorganism might block the opening.

### SUMMARY OF THE INVENTION

The present invention is to provide a liquid pipetting apparatus with strengthened washing function to prevent the tip opening of the dispensing head being blocked, and to provide a method of washing the dispensing head for preventing the tip opening of the dispensing head being blocked.

According to the present invention, there is provided a liquid pipetting apparatus for sucking and discharging a minute amount of liquid, comprising, a dispensing head having first opening for sucking and discharging liquid at one end of the discharging head, and second opening for draining the liquid an another end, and for holding the liquid inside thereof, a washing tank for holding cleaning solution to wash the inside of the dispensing head, means for washing the inside of the dispensing head to wash the inside of the dispensing head by sucking the cleaning solution from the first opening under the state of soaking one end of the dispensing head in the washing tank, and to drain the sucked cleaning solution from above the second opening.

In the present invention, the cleaning solution is sucked from the first opening, thereby washing inside of the dispensing head, by operating the means for washing the inside of the dispensing head under the state of soaking the one end of the dispensing head with the first opening, into the cleaning solution held in the washing tank and the sucked cleaning solution is drained from the second opening provided to the other end of the dispensing head. According to the present invention, in this case, the liquid passing through the first opening, is only a cleaning solution, so that inside of the dispensing head can be washed preventing causing contamination and blocking of the dispensing head, and thus a liquid pipetting apparatus with strengthened washing function, can be provided.

Preferably, according to the present invention, the means for washing the inside of the dispensing head comprises a decompressing tank and a vacuum pump connected to the second opening of the dispensing head in order, respectively.

Preferably, the means for washing the inside of the dispensing head comprises a syringe piston pump connected to the second opening of the dispensing head.

Preferably, according to the present invention, the washing tank is provided with means for generating an ultrasound wave vibration, and supersonic vibration generated by the ultrasound wave vibration generation means, is added to the dispensing head through the cleaning solution.

Preferably, according to the present invention, the washing tank is provided with a cover having an insertion opening capable of inserting the end portion of the dispensing head and capable of being opened and closed.

According to the present invention, there is provided a method of washing a dispensing head which pipettes a minute amount of liquid, comprising a sucking and washing step for washing the inside of the dispensing head by soaking the first opening provided to the dispensing head and for the suck and the discharge of the liquid, in the cleaning solution, and by sucking the cleaning solution from the first opening, and a draining step for draining the sucked cleaning solution out of the second opening of the dispensing head.

Preferably, in the present invention, in the sucking and washing step, the supersonic vibration is added to the cleaning solution. Moreover, according to the present invention, in the sucking and cleaning process, the ultrasonic vibration is added to the cleaning solution, in which the dispensing head is soaked.

### BRIEF EXPLANATION OF DRAWING

FIG. 1 is a diagram showing a whole construction of a liquid pipetting apparatus of first embodiment of the present invention schematically,

FIG. 2 is a cross-sectional view showing the construction of a dispensing head of the liquid pipetting apparatus in the first embodiment,

FIG. 3 is a diagram illustrating the driving voltage wave-form applied to a piezoelectric element of the dispensing head of the liquid pipetting apparatus in the first embodiment,

FIGS. 4(a)-(e) are diagrams for explaining the discharge principle of the specimen liquid drop according to the dispensing head of the liquid pipetting apparatus of the first embodiment,

FIG. 5 is a diagram showing the construction of the principal portion of the liquid pipetting apparatus of second embodiment of the present invention,

FIG. 6 is a diagram showing the construction of a conventional minute amount fluid processing unit,

FIG. 7 is a detailed view showing the micro dispenser of the minute amount fluid processing unit in FIG. 6, and

FIG. 8 is a diagram showing the specimen container used with the shown in minute amount fluid processing unit in FIG. 6.

### DETAILED EXPLANATION OF SUITABLE EMBODIMENT

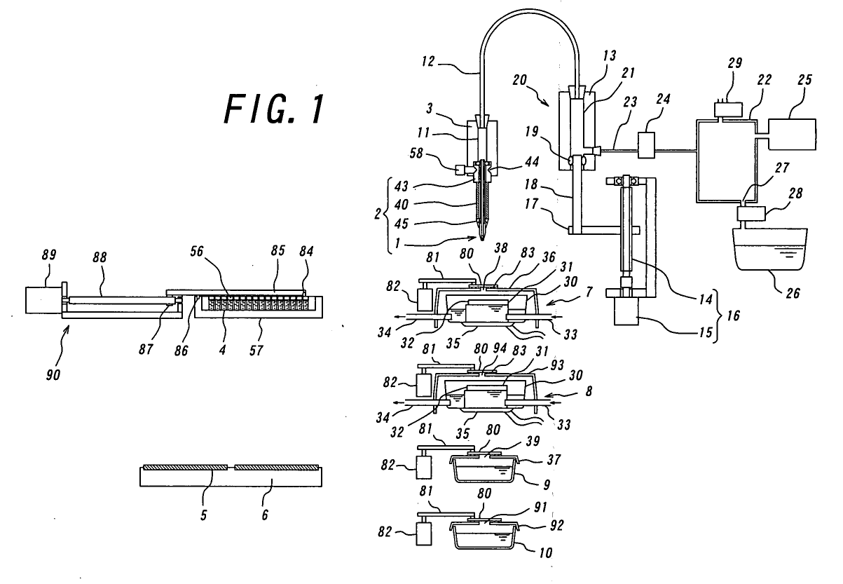

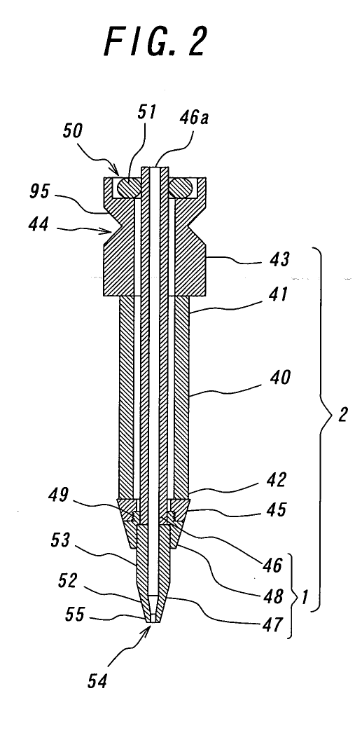

Hereafter, the embodiments of the present invention are explained in detail with reference to the drawing. FIG. 1 is a diagram showing a whole construction of a liquid pipetting apparatus of first embodiment of the present invention, schematically, and FIG. 2 is a cross-sectional view showing the construction of a dispensing head of the liquid pipetting apparatus of first embodiment.

In the liquid pipetting apparatus of this embodiment, as shown in FIG. 1, a head stage 3 capable of holding one or plural dispensing heads 2 (hereafter, referred to as a head) including a nozzle 1, is supported to a movable transportation member (not shown). The head stage 3 is constructed in such a manner that the stage 3 can be moved sequentially on upper side of each of a specimen container 4, a reactor vessel 5, a primary washing tank 7, a secondary washing tank 8, a sterilizing tank 9, and a system fluid tank 10. The movable transportation member has a driving source consisting of, for example, a precision ball screw and a pulse motor, and has a resolution of 0.001 mm/pls (pulse) or less in order to be able to ensure a desired positioning precision.

A conduit 11 formed in the head stage 3 has flexible property, and is connected to a syringe 13 by a translator tube 12 with a small capacity change. The syringes 13 are combined with pistons 18 connected with a movable section 17 of an electrical actuator 16 consisting of a precision ball screw 14 and a pulse motor 15, thereby constituting a syringe piston pump 20 to generate the volume change by moving the piston 18 through a sealing member 19. The resolution of the electrical actuator 16 is set to for example, 0.0001 mm/pls so as to be able to ensure the precision of movement of the piston 18.

A wasted fluid tube 23 has one end communicated with a decompressing tank 22 and has other end connected to a syringe conduit 21 of the syringe 13 and a conduit switching valve 24 is provided on the way of a wasted fluid tube 23. The decompressing tank 22 is so constituted that the waste fluid can be held inside and a vacuum pump 25 is connected to the downstream side thereof, so that the inside of the tank can be decompressed to an enough, negative pressure. A wasted fluid opening 27 communicated to a wasted fluid tank 26 is provided to the vicinity of the bottom surface of the decompressing tank 22, the decompressing tank 22 and wasted fluid tank 26 are communicated to each other by opening a wasted fluid opening valve 28 capable of being opened and shut. A tank opening valve 29 for communicating to atmosphere, is provided to the top surface neighborhood of the decompressing tank 22 and a pressure in the decompressing tank 22 is opened to the atmospheric pressure by opening the tank opening valve 29.

It has been described in FIG. 1, that the primary washing tank 7, the secondary washing tank 8, the sterilizing tank 9, and the system fluid tank 10 are arranged in the vertical direction for convenience′ sake, but actually, the secondary washing tank 8, the sterilizing tank 9, and the system fluid tank 10 are arranged on the plane and coplaner primary washing tank's 7 being arranged. The nozzle 1 of the head 2 can be soaked in the position of predetermined depth of respective tanks in order, by moving the head stage 3 in the vertical direction, after moving the head stage 3 over respective tanks of the primary washing tank 7, the secondary washing tank 8, the sterilizing tank 9, and the system fluid tank 10 in parallel by the movable transportation member (not shown).

The primary washing tank 7 and the secondary washing tank 8 are made almost same construction, and each of the primary washing tank 7 and the secondary washing tank 8 have an outer frame 30 and an inner frame 31. The height of the inner frame 31 is made lower than the height of the outer frame 30, a notch 32 is provided at a part of the upper edge of the inner frame 31. In the primary washing tank 7 and the secondary washing tank 8, a supply tube 33 is extended through the outer frame 30 from the outside and connected to the inner frame 31, so that the cleaning solution can be supplied into the inner frame 31 by the supply tube 33. In addition, in the primary washing tank 7 and the secondary washing tank 8, a drain tube 34 lead to outside is connected to the outer frame 30 so that the cleaning solution can be drained by the drain tube 34. Therefore, the cleaning solution supplied by the supply pipe 33 fills inside of inner frame 31, afterwards, overflows from the notch 32, and overflows from the notch 32, and pools between the outer frame 30 and the inner frame 31, and then is drained by the drain tube 34, so that the level of the cleaning solution in the inner frame 31 is kept constant. Moreover, these primary washing tank 7 and the secondary washing tank 8 are mounted with an ultrasonic transducer 35 at the other side of the bottom surface, so that the ultrasonic vibration of the frequency (for example, 20 kHz-3 MHz and in this embodiment, 40 kHz) having the washing effect can be added to the primary washing tank 7 and the secondary washing tank 8 by the driving circuit (not shown).

Moreover, the liquid sending to the supply pipe 33 and the liquid draining from drain tube 34 are performed by the liquid sending pump (not shown), and thus a clean liquid with the washing effect and quality managed is used as a cleaning solution. For example, the surface-active agent solution and alkaline solution or acid solution are used for the primary washing tank 7, and ultrapure water is used for the secondary washing tank 8. Moreover, the exchangeable filtration filter (not shown) for the foreign body removal, is located to the supply pipe 33. Moreover, the upper part of the primary washing tank 7 is covered with a lid for dustproof by using a covering 36 having a nozzle insertion hall 38, similarly, the upper part of the secondary washing tank 8 is covered with a lid for dustproof by using the covering 36 having a nozzle insertion hall 39. These nozzle insertion halls 38 and 94 are constructed so as to be able to open and close, by turning and driving a shutter 80 by a rotary actuator 82 through an arm 81, and is sealed up by a sealing member 83 at the closed state.

The sterilizing tank 9 has solvent resistance, and the upper part of the sterilizing tank 9 is covered with a lid for dustproof by using a covering 37 having the nozzle insertion hall 39. The sterilizing tank 9 is a container constructed in such a manner that the nozzle insertion hall 39 can be opened and closed as well as the nozzle insertion hall of the primary washing tank 7 and the secondary washing tank 8, and the organic solvent (for example, 70% isopropanol), having the disinfection effect such as sterilization and sterilization, etc., is supplied to the container, thereby holding a predetermined water level. Similarly, the system fluid tank 10 is also a container constructed in such a manner that the upper part of the system fluid tank 10 is covered with a lid for dustproof by using a covering 92 having the nozzle insertion hall 91, and thus the degassed stable liquid (for example, ultrapure water) is supplied from the outside, thereby holding a predetermined water level. Moreover, the covering 36 of the primary washing tank 7 and the covering 93 of the secondary washing tank 8 are made a shape in such a manner that whole is covered so as not to contact with respective washing tanks and so as not to obstruct the added efficiency of the ultrasonic vibration due to the ultrasonic transducer, and the covering 37 of the sterilizing tank 9 and the covering 92 of the system fluid tank 10 are made lid shape. Moreover, the control for opening respective nozzle insertion halls synchronizing with operation for soaking the nozzle 1, is performed, so as to open nozzle insertion halls 38, 94, 39, and 91 respectively only according to the prescribed timing with which the nozzle 1 is soaked.

The head 2 is constructed to the head stage 3 detachable, and comprises as shown in FIG. 2, the nozzle 1, and a piezoelectric element 40 etc. that can be transformed axially (the same as the discharging direction) to drive the nozzle 1 in the discharging direction (shown vertical direction). The piezo-electric element 40 has one edge portion 41 (shown upper edge portion) axially which is secured to a fixed end coupling 43 capable of being fitted in the fitting hole formed in the head stage 3, and another end portion 42 (shown bottom portion) which is secured to the upper end of a free end coupling 45 having a screw section 49 at the inner periphery.

Moreover, the nozzle 1 comprises a hollow cylindrical shaped nozzle tube 46 capable of holding liquid, a nozzle tip 47 of the inner diameter coincided substantially with the nozzle tube 46 and having tapered tip, and a conduit coupling 48 connected continuously to the nozzle tube 46 and the nozzle tip 47 at inside surface, thereby forming a conduit in inside of the nozzle tube 46 and the nozzle tip 47. The free end coupling 45 and the conduit coupling 48 can be coupled and separated simply by the screw section 49, and the head 2 is assembled to obtain the coaxiality of each member under the state coupling the both couplings. Moreover, the upper end portion of the shown nozzle tube 46 is provided with an opening 46a (herein after, referred to as a second opening), communicated to the conduit 11 of the head stage provided to the head stage 3.

Moreover, a V groove 44 is formed to the outer periphery of the engagement portion with the fitting hole formed to the head stage 3 of the fixed end coupling 43, when mounting the head 2 to the head stage 3, the head 2 can be fixed to the head stage 3 with a handy and enough pressure, by screwing a retaining screw 58 (refer to FIG. 1) of a spherical tip shape into slanted plane 95 over the V groove 44 under the fitting in state of the head 2. In addition, a concave section 50 having the prescribed inner diameter and depth is formed in the shown upper edge surface of the fixed end coupling 43. In this embodiment, the conduit sealed and communicated to the nozzle 1 from the head stage 3 is ensured by axially compressing and transforming one (or, plurality ) of O rings 51 fitted into the outer periphery at the edge of the nozzle tube 46 with the utilization of fixing pressure of the head 2 in the concave section 50. Moreover, the inner diameter of the concave section 50 is ensured very large in such a manner that the enhanced outer diameter is not restricted when the O ring 51 is transformed.

The nozzle tip 47 comprises a taper section 52 located on the tip side, and a straight section 53 having an inner diameter coincided substantially to the nozzle tube 46, and the nozzle tip 47 communicated to the external atmosphere at the opening 54 (first opening) provided to the tip (shown bottom). Outline dimensions of the straight section 53 are inner diameters 0.5 mm-3 mm, outer diameters 1.5 mm-6 mm, and 3 mm-60 mm in length, and the taper section 52 is formed to 5-20° in inner side and 25-45° in outer side. The size of the opening 54 has an opening diameter of 20 μm-100 μm, and an opening straight section 55 of 50-120 μm in length communicated to the inner of the taper section by this diameter. The coupling and the coupling portion between the piezoelectric element 40 and the nozzle 1 are formed as a rigid body, so that the nozzle 1 can be displaced in the vertical direction on the drawing by transforming the piezoelectric element 40. The voltage of the desired wave form is applied from the driving circuit (not shown) to the piezoelectric element 40 through lead wire or a flexible substrate. Moreover, ionized air is blown on the head 2 by a blower, if necessary, in order to prevent the dust in air from being adhered around the opening 54 by the electrified head 2, thereby removing static electricity.

The specimen container 4 as shown in FIG. 1 uses a specimen container of the resin molded article having for example, a plurality of concave sections 56 arranged in the matrix shape is had by 8×12 columns=96 holes and 16×24 columns=384 holes and 32×48 columns=1536 holes etc. The specimen container 4 is constructed in such a manner that the specimen can be held to inside of the concave section 56 by horizontally locating the sample container stage 57. In the specimen container 4, specimen liquid of a single kind or two or more kinds, for example a liquid in which for example, DNA and protein, a cell culture solution, a functional particle, and the cell are distributed, is previously pipetted by a constant amount. Moreover, the specimen container 4 can insert the nozzle tip 47 in desired concave section 56 by moving the head stage 3 under the conditions located to the liquid pipetting apparatus of this embodiment. Moreover, when the relative position between the nozzle tip 47 and the concave section 56 is controlled, the above positioning is not limited to the movement of the above described head stage 3, the positioning may be achieved by moving sample container stage 57 by another movable transportation member (not shown).

The shutter mechanism is constructed on the top surface of the specimen container 4 by providing electric actuator 90, in order to control the mixing of the foreign body in the specimen etc. and the concentration change according to the dryness of the specimen held in the specimen container 4. The shutter mechanism is constructed in such a manner that a shutter 85 connected to a movable section 87 may move straight in the horizontal direction by rotating and driving a precision ball screw 88 with a pulse motor 89, and thus the region covered with the shutter 85 is sealed up by a sealing member 86 that does not move and fitted to the top surface of the sample container stage 57, and by a sealing member 84 fitted under the shutter 85 and moved together with the shutter 85. Moreover, the air-conditioning mechanism may be installed to keep the temperature and the humidity of the installation atmosphere of specimen container 4 to be appropriate.

As the reactor vessel 5, for example, a glass plate capable of being optically visual observed, a plate shaped member to which preprocessing for reaction was given, a plate shaped member to which well for distribution of specimen is previously provided, and a molding member etc. can be utilized, and thus single or plural reactor vessels 5 may be located to a predetermined position of reactor vessel stand 6. Moreover, the head stage 3 can be positioned at a predetermined position on the reactor vessel 5 in order, to distribute the specimen to the prescribed part of the reactor vessel 5 by the head stage 3. When the relative position of both the head stage 3 and the reactor vessel 5 is controlled for the positioning, the feature of moving the head stage 3 is not limited, and the positioning may be performed by moving the reactor vessel stand 6 with the movable transportation member (not shown).

Next, various operations of the liquid pipetting apparatus according to the present embodiment are explained. Washing operation of the nozzle in the primary washing tank 7. The outer periphery portion washing step for washing the tip outer periphery portion of the nozzle 1, is performed as follows. First of all, the head stage 3 is descended after moving the head stage 3 above the primary washing tank 7. In that case, a shutter 80 of the covering 36 is put into an open state, the nozzle 1 is inserted from the nozzle insertion hall 38 into the primary washing tank 7 without touching the nozzle 1 to the covering 36, and soaked up to a predetermined depth in the cleaning solution held by a constant water level in the inner frame 31. Afterwards, the ultrasonic wave vibrator 35 is vibrated by the prescribed frequency by a driving circuit (not shown), and the supply pipe 33 supplies a new cleaning solution by the liquid sending pump (not shown), at the same time, the cleaning solution after circulated from the drain tube 34 in the tank is sucked and disposed of. As a result, the washing effect according to the cleaning solution constituent and the washing effect according to the ultrasonic wave vibration are caused outside of the soaked nozzle 1, so that the adhered specimen, contamination, and the foreign body are removed. In that case, the removed substance is drained from the primary washing tank 7 together with the cleaning solution, at the same time, a new cleaning solution flows in, thereby controlling the re-attachment to the surface of the nozzle 1, so that washing the outer periphery portion of the nozzle 1 is promoted.

The inside washing step of the nozzle is performed in parallel with the washing of the nozzle outer periphery portion in the above primary washing tank 7 as follows. First of all, the conduit switching valve 24 is put into an open state, the tank opening valve 29 and the wasted fluid opening valve 28 are put into a close state, and then the vacuum pump 25 is made operated in this condition. At this time, inside of the decompressing tank 22 is decompressed from the atmospheric pressure, so that the inside of the nozzle 1 is decompressed through the wasted fluid tube 23, the syringe conduit 21, the translator tube 12, and the conduit 11 of the head stage 3. By this decompression, the cleaning solution is sucked from the opening 54 of the nozzle 1 inside and flows with the designated velocity (for example, prescribed high speed) in the nozzle 1, so that the specimen, contamination, and the foreign body adhered to the inner surface of the nozzle 1, respectively are removed. Moreover, a clean cleaning solution via the filter is supplied to the primary washing tank 7, the foreign body from outside the tank is prevented being mixed by the covering 36 and the shutter 80, so that the foreign body is prevented from being sucked out of the opening 54 when the cleaning solution is sucked.

At the above washing operation, by strengthening the decompression level with the vacuum pump 25, flow velocity in the nozzle 1 must not only be speed up but also in the case of using of surface active agent as a cleaning solution, or the like bubble generates successively according to the cavitations, so that the washing effect is promoted by the stirring effect in the conduit according to the movement of the bubble. In addition, the bubbling operation increases further by performing the sucking at the same time an addition of the ultrasonic vibration, so that the washing effect is promoted compared with the case of performing only the sucking.

Washing operation of the nozzle in the secondary washing tank:

After performing the above washing operation by the primary washing tank 7 during the predetermined time, the head stage 3 is raised and nozzle 1 is saved from the primary washing tank 7. Afterwards, the head stage 3 descends after moving the head stage 3 above secondary washing tank 8. In that case, a shutter 80 of the covering 93 is put into an open state, the nozzle 1 is inserted from the nozzle insertion hall 94 into the primary washing tank 8 without touching the nozzle 1 to the covering 93, and is soaked up to a predetermined depth in the ultrapure water held by a constant water level in the inner frame 31. Afterwards, in the same way as the above, the outer periphery portion and the inside of the nozzle are washed with the circulating ultrapure water. As a result, the cleaning solution such as remained surface active agents remained in case of the washing according to the primary washing tank 7 is rinsed, and will be removed.

Sucking Operation of System Fluid:

After operating the washing by the secondary washing tank 8, the head stage 3 is raised and nozzle 1 is saved from the secondary washing tank 8. Afterwards, the head stage 3 descends after moving the head stage 3 above the system fluid tank 10, and then the nozzle 1 is inserted from the nozzle insertion hall 91 of the covering 92, by which the shutter 80 is made an open state, in system fluid tank 10, thereby soaking the nozzle 1 into the system fluid. Under such a condition, in the same as in the above, the system fluid is sucked from the opening 54 of the nozzle 1, by operating the vacuum pump 25 under the condition that the conduit switching valve 24 is put into an open state, the tank opening valve 29 and the wasted fluid opening valve 28 are put into a close state, and then the conduit switching valve 24 is shut and the sucking is stopped, after putting in the state to fill the part from the opening 54 of the nozzle 1 to the conduit switching valve 24 with the system fluid. At this time, it is assumed to put it into the state to insert the piston 18 in the syringe 13 most in the syringe piston pump 20.

Moreover, in the case of making the sucking amount and the discharge amount of the specimen stable strictly, there is a possibility that the sucking amount and the discharge amount of the specimen vary by the expansion of the bubble in the conduit, so that when liquid is sucked in the secondary washing tank 8 or the system fluid tank 10 the generated bubble is transported to the position in which bubble is passed through the conduit switching valve 24 by making the generated bubble low-level decompression, and thus it is preferable to remove bubble enough from the conduit to which the influence on the bubble is expected.

Sucking Operation of the Specimen

The nozzle 1 is saved from the system fluid tank 10 by raising the head stage 3 under the state that the part from the opening 54 of the nozzle 1 to the conduit switching valve 24 is filled with the system fluid. Afterwards, in the syringe piston pump 20, air is sucked from the nozzle opening 54 in the nozzle 1 by moving the piston 18 with the given amount in the direction of pulling out in low speed. In that case, the interface between the system fluid layer and the air space is formed without generating the bubble in the conduit, by controlling the moving amount and the mobile velocity of the piston 18 in precision, the pressure of both layers is made stable by making geostationary only at the predetermined time. Moreover, depending on the required conditions, sucking operation of the system fluid is not performed, the sucking of air also has the case performed by operating of the vacuum pump 25 and the opening and shutting of respective valves.

The head stage 3 is moved above the specimen container 4 with the state to fill the tip side of the nozzle 1 (the opening 54 side) with air. Afterwards, the nozzle 1 inserts in the prescribed concave section 56 up to predetermined depth by controlling the relative position of the head stage 3 and the specimen container 4 without touching the nozzle 1. In that case, the shutter 85 is moved to open the upper side of the concave section 56 to be inserted, by controlling the motion of the electrical actuator 90 before insertion. And, afterwards, in the syringe piston pump 20, the spacemen held in the concave section 56 is sucked from the nozzle opening 54 in the nozzle 1 by moving the piston 18 with the given amount in the direction of pulling out in low speed further. Even here, the interface between the spacemen layer and the air space is formed, by controlling the moving amount and the mobile velocity of the piston 18 in precision, the pressure of both layers is made stable by making geostationary only at the predetermined time. Moreover, in the case of having a construction provided with the head 2 in two or more systems, the nozzle 1 in the system that needs the sucking is controlled to suck the specimen at the same time. Moreover, after the completion of the sucking, the nozzle 1 is saved above the specimen container 4, the shutter 85 is moved and a predetermined region of the specimen container 4 is sealed up, if necessary.

Discharging Operation of the Specimen

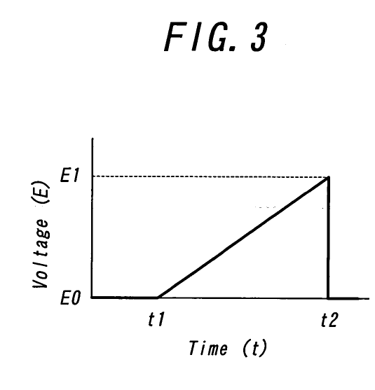

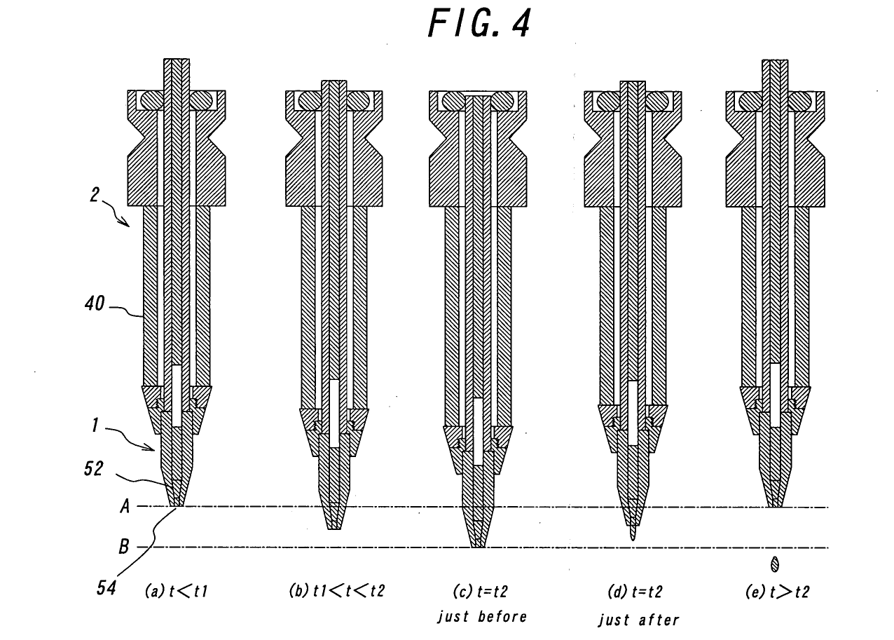

After the completion of the specimen sucking operation, the head stage 3 is moved above the reactor vessel 5 under the state of holding the specimen in the nozzle 1. Afterwards, the relative position between the head stage 3 and the reactor vessel 5 is controlled, the drop of the specimen liquid is discharged to distribute the specimen to the prescribed position of the reactor vessel 5. The discharge operation of the specimen liquid drop is performed by applying the driving voltage wave form shown in FIG. 3 to the piezoelectric element 40 of the head 2. That is, when assuming the position of the tip of the head 2 when the voltage of E=E0 is applied to the piezoelectric element 40 to be shown in FIG. 4(a), as A, the nozzle 1 is displaced gradually in the downward direction on the drawing as shown in FIG. 4(b), according to a gradual ascending of the applied voltage, by applying the voltage that rises gradually between t1<t<t2 of FIG. 3 toward E=E1 from E=E0 to the piezoelectric element 40.

At the time immediately before t=t2 in FIG. 3, the transformation corresponding to the voltage E=E¹ as shown in FIG. 4(c) is caused in the piezoelectric element 40, so that the tip of the nozzle 1 descends to the position of B shown in the drawing. Afterwards, at the time immediately after t=t2 in FIG. 3, the voltage applied to the piezoelectric element 40, decreases instantaneously from E=E1 to E=E0, so that the nozzle 1 is rapidly displaced in the upper direction of the drawing as shown in FIG. 4(d) according as the voltage decreases suddenly. At this time, inertia force acts on the specimen in the nozzle 1, so that the specimen in nozzle 1 moves in the downward direction of drawing simultaneously and momentarily. The pressure in the tip of the taper section 52 in the nozzle 1 rises by moving the specimen, as a result, the surface tension on the opening 54 is broken, and thus after t>t2 of FIG. 3 as shown in FIG. 4(e), a part of the specimen is discharged outside as a liquid drop.

The discharge amount of the liquid in that case is decided by the aperture of inclination angle of the taper section 52 in the nozzle 1 and the opening 54 and driving voltage wave forms, etc., and the range thereof is about 0.01 μl-0.3 μL. Moreover, it is also possible to set a total discharge amount by adjusting the discharge number of the liquid drop, in case of repeating the discharge by assuming the volume of one liquid drop to be a unit discharge amount. Moreover, the relation between the sucking amount of the specimen and the driving voltage wave form of the piezoelectric element 40 is made optimized so as to ensure the excellent discharge quality stably.

Moreover, in case of adopting a system configuration that uses the head 2 in plural systems, a moving distance is made shortest, thereby ensuring the discharge efficiency, by alternately discharging the head 2 in respective systems according to the movement of the relative position of respective head stages 3 and the reactor vessel 5. Moreover, the specimen liquid drop is continuously discharged to a predetermined position of the reactor vessel 5 by using the same head, and the stability of the discharge quality is made ensured by switching the head in order.

After completing the discharge operation of the specimen liquid drop to above mentioned reactor vessel 5, in order to shift to the discharge operation of another specimen liquid drop, a serial operation from the above washing operation in the primary washing tank 7 to the sucking operation of the system fluid is repeated. Thereafter, a necessary cycle is executed repeatedly according to the kind of the discharging specimen, thereby completing the distribution of the specimen like desired.

Moreover, in respective cycles of the above described specimen discharge operation, the liquid sucked from the primary washing tank 7, the secondary washing tank 8, the system fluid tank 10, and the specimen container 4 is transported to the decompressing tank 22, and stays in the decompressing tank 22. In the discarding step of the liquid stayed in such decompressing tank 22, the tank opening valve 29 and the waste fluid valve 28 are opened under the state that the vacuum pump 25 is stopped, and a stayed unnecessary liquid is drained from the wasted fluid opening 27 to the wasted fluid tank 26, and discarded. Moreover, in the case of causing the disinfected necessity, after moving the head 2 above the sterilizing tank 9 according to the prescribed timing, the tank 2 is made descended, the nozzle 1 is inserted from the nozzle insertion hall 39 of the covering 37 and soaked in the disinfection layer 9, afterwards, the organic solvent etc. with the antiseptic effects of sterilization, and disinfection etc. is sucked from the opening 54 of the nozzle 1 in the nozzle 1, by operating the vacuum pump 25 under the condition that the conduit switching valve 24 is put into an open state, and the tank opening valve 29 and the wasted fluid opening valve 28 are put into a close state. In the case of existing the microorganism in the conduit of the nozzle 1, the microorganism is prevented from breeding by sucking such an organic solvent with the antiseptic effect.

According to the liquid pipetting apparatus of this embodiment, in the outer periphery portion washing step for washing the tip outer periphery portion of the nozzle 1, substances such as the specimen, foreign bodies, and micro-organisms that adhere to the nozzle outer periphery portion are removed, and in the outer periphery portion washing step for washing the inner periphery portion of the nozzle 1, by using the cleaning solution sucked from the opening 54 to inside of the head 2, substances such as the specimen, the foreign bodies, and the microorganisms that remained in the conduit etc. in inside of the nozzle are drained outside of the head 2 through the head stage conduit 11 of the head stage 3 and the opening 46a of the nozzle tube 46 of the head 2, thereby washing inside of the dispensing head. In that case, the liquid passing through the opening 54, is only a cleaning solution, the foreign body and the microorganism, etc. are drained outside without passing through the opening 54, so that the opening 54 of the extremely minute diameter provided to the nozzle 1 is prevented from being blocked. Therefore, the liquid pipetting apparatus having the strengthened washing capability can be provided in order to prevent the opening 54 of the dispensing head from being blocked.

Moreover, hitherto, in order to prevent whole the foreign body mixing and the generation of the microorganism on the conduit, continuously, work for managing the maintenance of clean degree of the entire conduit is indispensable, in such a manner that the liquids supplied to the liquid pipetting apparatus, such as the cleaning solutions, the system fluids, and organic solvents are transported to the nozzle tip under cleanly states. However, in the liquid pipetting apparatus of this embodiment, the above respective liquids was made to suck directly from the corresponding tank into the inside of the nozzle, so that the conduit for the transportation up to the nozzle becomes unnecessary, the covering with the insertion opening of the nozzle is provided for respective tanks, the insertion opening is made closed, except when the nozzle is inserted, thereby only preventing the foreign body from being mixed, and thus the time of the managing work with a complex clean degree (securing of clean degree of respective members of the piping as a conduit and coupling, etc. and assembly environments of these members, continuous operation at any time to prevent generation of mold etc. in the conduit, and sterilization and return work etc. of regular conduit according to the circulation of drug solution) can be reduced.

Moreover, a vacuum pump is used as the sucking driving source of the cleaning solution used for the inner periphery washing, so that flow velocity in the head can be improved by strengthening the decompression level and thus detergency can be strengthened according to desire. Moreover, in the case of using of surface active agent as a cleaning solution, bubble successively generates so that the washing effect can be promoted by the stirring effect in the conduit according to the movement of the bubble.

Moreover, the ultrasonic wave vibrator 35 is installed respectively the primary washing tank 7 and the secondary washing tank 8, so that by adding supersonic vibration generated by the ultrasonic wave vibrator 35 to the dispensing head 2 through the cleaning solution, thereby promoting the washing effect of the head, and in case of sucking the cleaning solution to inside of the head continuously, the bubbling effect according to the cavitations in the head increases, and thus the washing effect in the dispensing head can be promoted further as compared with the case that the ultrasonic vibration is not added.

Moreover, in the above first embodiment, the nozzle 1 is made reciprocating movement in the discharging direction and means for discharging the liquid by inertia force as a head 2, is used, but instead thereof, the liquid may be discharged by shrinking the piezo-electric ceramics of the cylindrical shape in the radial direction, and by changing the capacity of the nozzle. Moreover, in the above first embodiment, the means for forming and discharging the liquid drop is used as a head 2, but instead thereof, the means for discharging the liquid continuously is used by improving pressure in the nozzle. In addition, in the above first embodiment, the means that only the opening (opening 54) becomes most small diameter, is used as a nozzle, but instead thereof, needle means where the small diameter part is consecutive axially by only predetermined length, may be used.

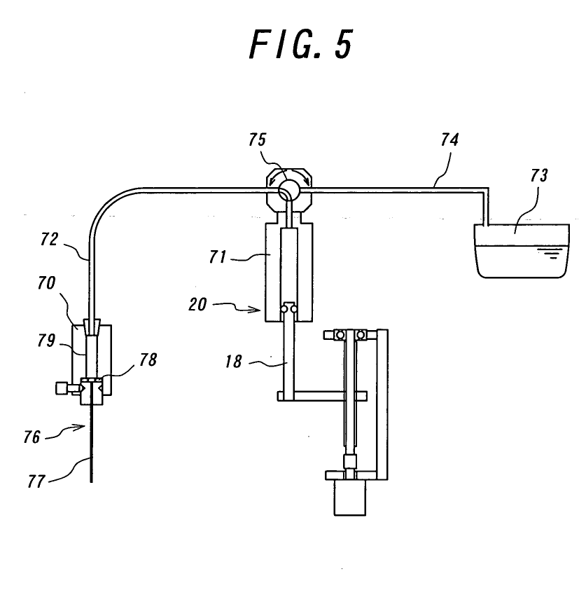

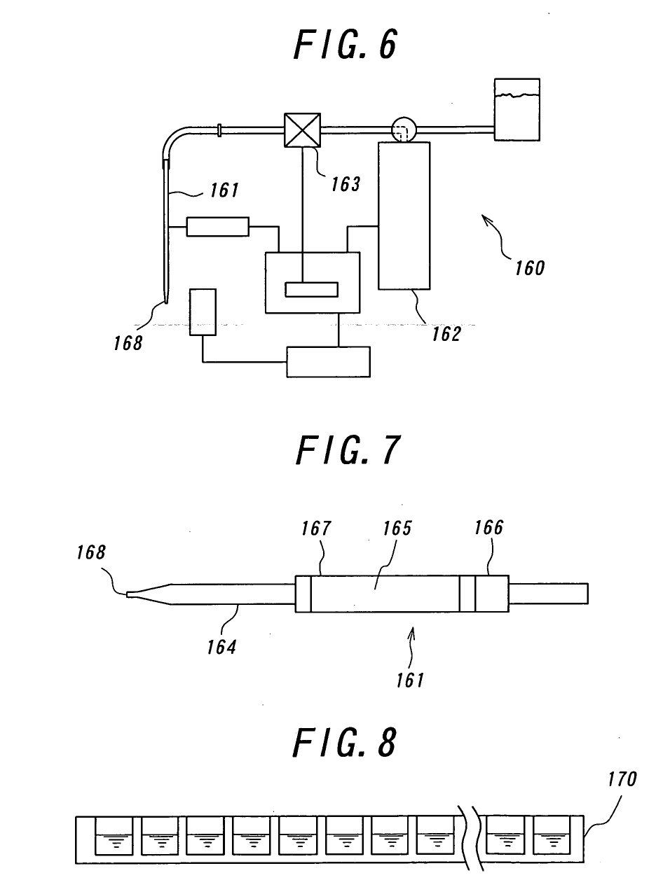

FIG. 5 is a diagram showing the construction of the principal portion of the liquid pipetting apparatus of second embodiment according to the present invention. The liquid pipetting apparatus according to this embodiment is constructed by changing the construction of the sucking and driving system of the cleaning solution used to wash the nozzle inner part for the liquid pipetting apparatus of first embodiment. The same sign is put on the same part as the first embodiment, and the explanation thereof is omitted. Moreover, in FIG. 5, the description of respective tanks, the specimen container 4, and the reactor vessel 5 of the primary washing tank 8 etc. is omitted.

In the liquid pipetting apparatus of this embodiment, a head 76 is constructed as well as the first embodiment, the one end of a translator tube 72 is connected to the upper end portion (not shown) of a head stage conduit 79 in a head stages 70 connected to the upper part of the head 76, and the other end of the translator tube 72 is connected to a three-way valve 75. As the translator tube 72, the tube having flexibility and less volume change is used (in other words, tube that might not swell by the internal pressure, but curved) is used, and the translator tube 72 and a wasted fluid tube 74 communicated to a wasted fluid tank 73 are connected to the upper end portion of a syringe 71 of the syringe piston pump 20 through the three-way valve 75. The three-way valve 75 is alternately switched between the inside of the syringe 71 and translator tube 72 and between the inside of the syringe 71 and the wasted fluid tube 74 by rotating the rotor, in which the conduit is formed inside thereof, and the rotary actuator (not shown) is used as a driving source. As a rotary actuator, for example, the member, with which the rotary solenoid is connected to the rotor through the torque transmission member, is used. Moreover, the valve is not provided on the conduit of the wasted fluid tube 74.

The above head 76 comprises the head stage 70, and a needle nozzle 77 having an opening of very small diameter and detachable with the head stage 70. The detachable portion of the nozzle 77 to the head stage 70 is filled with the sealing member of an O ring 78 etc, and the air-tight with the conduit 79 of the head stage has been constructed to be ensured.

Next, various operations of the liquid pipetting apparatus according to the present embodiment are explained. First of all, after obtaining the condition that the syringe piston pump 20 is driven, and the piston 18 is inserted as deep as possible in the syringe 71, the three-way valve 75 is driven and the translator tube 72 and the syringe 71 are made communicated. Under such a condition, after the head stage 70 is moved above the primary washing tank 7, it shifts to the outer periphery portion cleaning process of the nozzle 77 similar to the first embodiment.

After starting the washing of the outer periphery portion of the nozzle 77, in order to execute an inner cleaning process of the nozzle 77 concurrently, the syringe piston pump 20 is driven, and the cleaning solution in the primary washing tank 7 is sucked at the prescribed speed. With such a sucking, substances such as the specimen, dirt, foreign bodies and microorganisms or the like that are adhered to the inner surface of the nozzle 77, are drained outside of the head 76 and removed, by flowing the cleaning solution sucked from the opening of the tip of the nozzle 77 inside the conduit in the nozzle 77 with the designated velocity (for example, prescribed high speed). At this time, the washing effect can be promoted by forming the decompressing condition corresponding to the inner diameter of the nozzle 77, by controlling the moving amount and the mobile velocity of the piston 18.

Moreover, the cleaning solution sucked from the nozzle 77 is drained outside from the wasted fluid tank in such a manner that the three-way valve 75 is driven and the rotor rotates 90 degrees around anti-clockwise direction of FIG. 5, after making the wasted fluid tube 74 and the syringe 71 communicated, by driving the syringe piston pump 20 and by moving the piston 18 to the vicinity of the initial position (the state that it is inserted as deep as possible in the syringe 71) the liquid is passed through the wasted fluid tube 74 and is transported to the wasted fluid tank 73. Such sucking operation and the drain-off operation are repeated given number of times.

Afterwards, as well as the first embodiment, the washing (rinsing) operation in the secondary washing tank 8, the sucking operation of the system fluid tank 10, the sucking operation of air, and the specimen operates, are performed, but the point to use the syringe piston pump 20 as a driving source of respective operations differs from the first embodiment. Moreover, there is a case that does not suck the system fluid or air either according to the conditions.

Afterwards, the head stage 70 is moved above the reactor vessel 5 under the state of holding the specimen in the nozzle 77, the relative position with the reactor vessel 5 is controlled and the head stage 70 is positioned, afterwards, the syringe piston pump 20 is driven, and the specimen of the given amount is discharged to the position of the reactor vessel 5, and distributed. In the discharge operation, it is adjusted that the specimen reaches in reactor vessel 5 in an appropriate form, by controlling the moving amount and the mobile velocity of the piston 18.

After completing the discharge operation of the specimen to above mentioned reactor vessel 5, in order to shift to the discharge operation of another specimen, a serial operation from the above washing operation in the primary washing tank 7 to the sucking operation of the system fluid is repeated. Thereafter, a necessary cycle is executed repeatedly according to the kind of the discharging specimen, thereby completing the distribution of the specimen like desired.

Moreover, in the case of causing the disinfected necessity, after moving the head 76 above the sterilizing tank 9 according to the prescribed timing, the head 76 is made descended, the nozzle 77 is inserted from the nozzle insertion hall 39 of the covering 37 and soaked in the disinfection layer 9, afterwards, the syringe piston pump 20 is driven, and the organic solvent etc. with the disinfection effect of sterilization etc. from the opening of nozzle 77 are sucked inside of the nozzle 77. In the case of existing the microorganism in the conduit of the nozzle 77, the microorganism is prevented from breeding by sucking the organic solvent with the antiseptic effect. According to the liquid pipetting apparatus of this embodiment, in addition to achieve the effect similar to the first embodiment, the washing operation, the suck operation of the specimen, and the discharge operation are performed only by the syringe piston pump 20 and a three-way valve 75, the sucking operation of the washing water can be co-used with the syringe piston pump 20 for the sucking and the discharging operations of the specimen, so that the construction of the liquid pipetting apparatus can be simplified. Moreover, the washing effect can be promoted by forming the desired decompressing condition in inside of the head 76 by controlling the moving amount and the mobile velocity of the piston 18 in the syringe piston pump 20.

Moreover, in the above second embodiment, member having the needle nozzle 77 as a head 76, is used, but instead thereof the member by which the liquid is discharged with the shape change etc. of the piezo-electric ceramics as well as the prior art and the first embodiment.

1. A liquid pipetting apparatus for sucking and discharging a minute amount of liquid, comprising: a dispensing head having first opening for sucking and discharging liquid at one end of the discharging head, and second opening for draining the liquid at another end, and for holding the liquid inside thereof, a washing tank for holding cleaning solution to wash the inside of the dispensing head, and means for washing the inside of the dispensing head to wash the inside of the dispensing head by sucking the cleaning solution from the first opening under the state of soaking one end of the dispensing head in the washing tank, and to drain the sucked cleaning solution from above the second opening, means for washing the inside of the dispensing head to wash the inside of the dispensing head by sucking the cleaning solution from the first opening under the state of soaking one end of the dispensing head in the washing tank, and to drain the sucked cleaning solution from above the second opening.

2. The liquid pipetting apparatus as claimed in claim 1, wherein the means for washing the inside of the dispensing head comprises a decompressing tank and a vacuum pump connected to the second opening of the dispensing head in order, respectively.

3. The liquid pipetting apparatus as claimed in claim 1, wherein the means for washing the inside of the dispensing head comprises a syringe piston pump connected to the second opening of the dispensing head.

4. The liquid pipetting apparatus as claimed in claim 1, wherein the washing tank is provided with means for generating an ultrasonic wave vibration, and ultrasonic wave vibration generated by the ultrasonic wave vibration generation means, is added to the dispensing head through the cleaning solution.

5. The liquid pipetting apparatus as claimed in claim 1, wherein the washing tank is provided with a cover having an insertion opening capable of inserting the end portion of the dispensing head and capable of being opened and closed.

6. A method of washing a dispensing head which pipettes a minute amount of liquid, comprising a sucking and washing step for washing the inside of the dispensing head by soaking the first opening provided to the dispensing head and for the suck and the discharge of the liquid, in the cleaning solution, and by sucking the cleaning solution from the first opening, and a draining step for draining the sucked cleaning solution out of the second opening of the dispensing head.

7. The dispensing head washing method as claimed in claim 6, wherein in the sucking and washing step, the ultrasonic wave vibration is added to the cleaning solution.
